(19) United States
(12) Patent Application Publication
(10) Pub. No.: US 2011/0073437 A1
(43) Pub. Date: Mar. 31, 2011

(54) STATION FOR RECEIVING PRODUCTS AND TEMPORARILY ACCOMMODATING THEM

(76) Inventor: Francesco Maria Bernardi, Bologna (IT)

(21) Appl. No.: 12/736,919

(22) PCT Filed: May 25, 2009
(86) PCT No.: PCT/EP2009/056315

§ 371 Date: Nov. 22, 2010

(30) Foreign Application Priority Data
May 26, 2008 (IT) BO2008A000331

(51) Int. Cl. B65G 47/00

(52) U.S. Cl. 198/347.1

(57) ABSTRACT

A station for receiving products and temporarily accommodating them, which comprises a compartment that is delimited by two mutually opposite side walls and by a back wall, which lies opposite an open side of the compartment that constitutes an inlet for products to be received and accommodated temporarily. The back wall is movable along a direction that is parallel to the side walls in order to vary the depth of the compartment and the side walls are movable along a direction that is parallel to the back wall in order to vary the width of the compartment. Each side wall is constituted by a useful portion of a containment element and the containment element is at least partially able to slide parallel to itself in order to vary the length of the useful portion.

The present invention relates to a station for receiving products and accommodating them temporarily.

### BACKGROUND OF THE INVENTION

In the field of packaging machines, for various kinds of articles, and particularly for rolls of paper of the tissue type (for example absorbent paper or toilet paper), machines are widespread which are capable of packaging a predefined number of rolls in order to define the packaging unit that is usually sold to the end consumer.

According to a known constructive solution, these machines first of all have devices for feeding the rolls, which are then picked up by handling means, for example conveyor belts or platforms. Along said means there are apparatuses that are capable of diverting the flow of part of the rolls in order to arrange them as a whole according to several rows or layers.

Once the rolls have been arranged in the desired configuration, they are delivered to a receiving station, which is provided in the main body of the machine; such station is capable of receiving and temporarily accommodating the rolls before a lifting unit (typically constituted by a pusher that can move along its own axis) sends them to a traction device, during which the actual wrapping cycle is performed.

Typically, such receiving station has a compartment that is adapted to accommodate groups of rolls that are already suitably dosed and adjusted: to ensure the possibility of accommodating groups formed by different numbers of rows and/or layers of rolls (optionally of different sizes), the back wall of such compartment and the two side walls must be adjustable. In other words, it must be possible to change the depth of the compartment (i.e., by acting along the roll arrival direction) and its width (by acting therefore transversely to the arrival direction).

Further, the back wall must be able to move in order to accompany and cushion the stopping stroke of the rolls, in order to prevent the impact with the wall from deteriorating them or simply modifying and compromising their orderly arrangement.

For these purposes, according to a first known constructive solution, the back wall can move along a guide (which is arranged along the roll arrival direction) in order to allow to adjust the depth of the compartment; as regards instead adjustment in terms of width, as the required format varies it is necessary to replace the flat element that constitutes such wall.

According to this solution, the side walls of the compartment are constituted by two other flat elements whose dimensions, in depth, are such as to contain the maximum format of the groups of rolls (therefore requiring no adjustment in this regard), while width adjustment is achieved by providing such flat elements with the possibility to perform a translational motion along a direction that is perpendicular to the arrival direction of the rolls.

It is evident that the described constructive solution has the drawback of requiring manual intervention of the operator whenever the dimensions of the group of rolls to be processed change, in order to replace the flat element that constitutes the back wall.

This drawback is overcome by a second constructive solution, of a known type, in which the back wall is constituted by a series of slats arranged next to each other and coupled to the same fulcrum (and to the same shock-absorbing element). As the width of the groups of rolls varies, the slats can be made to slide laterally along suitable guides, thus varying the extension of the back wall.

The described solution therefore allows to avoid the intervention of the operator, but has a high constructive complexity and increases the weight of the contrast elements, consequently degrading the shock-absorbing characteristics. Further, the slats are very fragile and this leads to frequent breakages as a consequence of repeated impacts with the rolls.

### SUMMARY OF THE INVENTION

The aim of the present invention is to solve the above-mentioned drawbacks, by providing a receiving and temporary accommodation station that allows to maintain high mechanical simplicity, at the same time limiting the intervention of the operator following a change of format of the products to be treated.

Within this aim, an object of the invention is to provide a station that is highly reliable and effective in operation.

Another object of the invention is to provide a station that can be obtained easily starting from commonly commercially available elements and materials.

Another object of the invention is to provide a station that has low costs and is safe in application.

This aim and these and other objects which will become better apparent hereinafter are achieved by a station for receiving products and temporarily accommodating them, which comprises a compartment that is delimited by two mutually opposite side walls and by a back wall, which lies opposite an open side of said compartment that constitutes an inlet for products to be received and accommodated temporarily, said back wall being movable along a direction that is parallel to said side walls in order to vary the depth of said compartment and said side walls being movable along a direction that is parallel to said back wall in order to vary the width of said compartment, characterized in that each one of said side walls is constituted by a useful portion of a containment element, said containment element being at least partially able to slide parallel to itself in order to vary the length of said useful portion.

### BRIEF DESCRIPTION OF THE DRAWINGS

Further characteristics and advantages of the invention will become better apparent from the following detailed description of a preferred but not exclusive embodiment of the station according to the invention, illustrated by way of non-limiting example in the accompanying drawings, wherein:

FIG. 1 is a plan view of a station according to the invention in a first configuration;

FIG. 2 is a plan view of the station according to the invention in a second configuration;

FIG. 3 is a front elevation view of a detail of the containment element.

### DESCRIPTION OF THE PREFERRED EMBODIMENTS

With reference to the figures, a receiving and temporary accommodation station according to the invention, generally designated by the reference numeral 1, comprises a compartment 2, which is capable of receiving and temporarily accommodating products 3 delivered by a handling and sorting unit 4, which is arranged upstream of the station 1.

The products 3 can be constituted by one or more rolls composed of a cylindrical core, on which a strip of paper of the tissue type, for example toilet paper or absorbent paper, is wound.

The rolls feed a packaging machine 5, which comprises the handling and sorting unit 4 capable of providing the desired grouping of rolls, and the station 1, which, as mentioned, is arranged downstream of the handling and sorting unit 4 and from which it receives the products 3.

Subsequently, the machine 5 has a transfer device that is capable of picking up the products 3 and sending them to the apparatuses assigned to their packaging: packaging provides for the execution of a wrapping cycle that is composed of a wrapping in a plastic film sheet and a subsequent folding and final heat-sealing of the flaps of the film.

For example, the above cited transfer device might be a lifting unit capable of pushing the products 3 toward a plurality of grip elements, capable of handling them while the wrapping cycle is performed on them.

The compartment 2 is delimited by two mutually opposite side walls 6 and by a back wall 7 that lies opposite an open side, which constitutes an inlet 8 for the products 3, delivered by the handling and sorting unit 4, that must be received and accommodated temporarily.

Depending on the commercial requirements and therefore on the intended sale format, the product 3 is constituted by a grouping composed of a variable number of rolls, arranged along several rows and/or layers.

The product 3 therefore has variable dimensions and the compartment 2 accordingly must be able to adapt to these variations in order to be able to accommodate it and retain it, before the transfer device sends it to the apparatuses assigned to the subsequent processes.

For this purpose, the back wall 7 can move along a direction that is parallel to the side walls 6, i.e. along the direction for introducing the products 3 in the compartment 2: in this manner it is possible to vary the depth of the compartment 2.

To allow this movement, the back wall 7 has a slider 9 that can slide along a track 10 that is oriented according to such direction.

Likewise, the side walls 6 can move along a direction that is parallel to the back wall 7, i.e., at right angles to the direction of insertion of the products 3 in the compartment 2, in order to vary the width of the compartment 2.

It should be noted immediately that the back wall 7 is provided with a shock-absorbing element, which acts along the insertion direction of the products 3, in order to allow the back wall 7 to accompany and cushion the stopping stroke of the products 3, thus avoiding dangerous impacts which might deteriorate the rolls or compromise their arrangement.

According to the invention, each side wall 6 is constituted by a useful portion 11a of a containment element 11, which can slide at least partially parallel to itself in order to vary the length of the useful portion 11a. By varying the length of the useful portion 11a and associating with such variation the sliding of the back wall 7 along the track 10, one obtains not only the result of modifying the length of the side wall 6 but also ultimately of varying the depth of the compartment 2 without requiring a change of the elements that constitute the side wall 6.

More particularly, the containment element 11 can slide along a predefined closed path 12, which has at least one first substantially straight extent 12a that faces the compartment 2.

A remaining portion 11b of the containment element 11 is arranged along the residual extent of the closed path 12, constituted by a second extent 12b, which is arranged outside the compartment 2 and is parallel to the first extent 12a, and by two annular portions, which mutually blend the first extent 12a and the second extent 12b.

It is thus evident that by means of the sliding of the containment element 11 along the closed path 12 it is possible to increase or decrease the part thereof that is arranged along the first extent 12a, such part constituting the useful portion 11a; the remaining portion 11b can be made to slide along one of the two annular portions and along the second extent 12b.

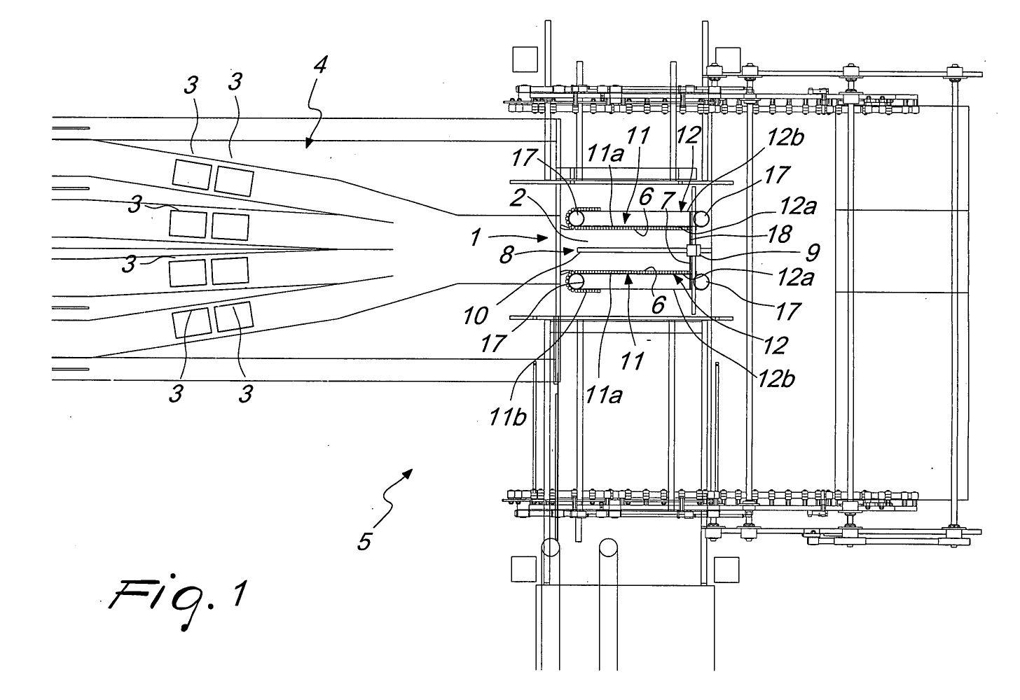

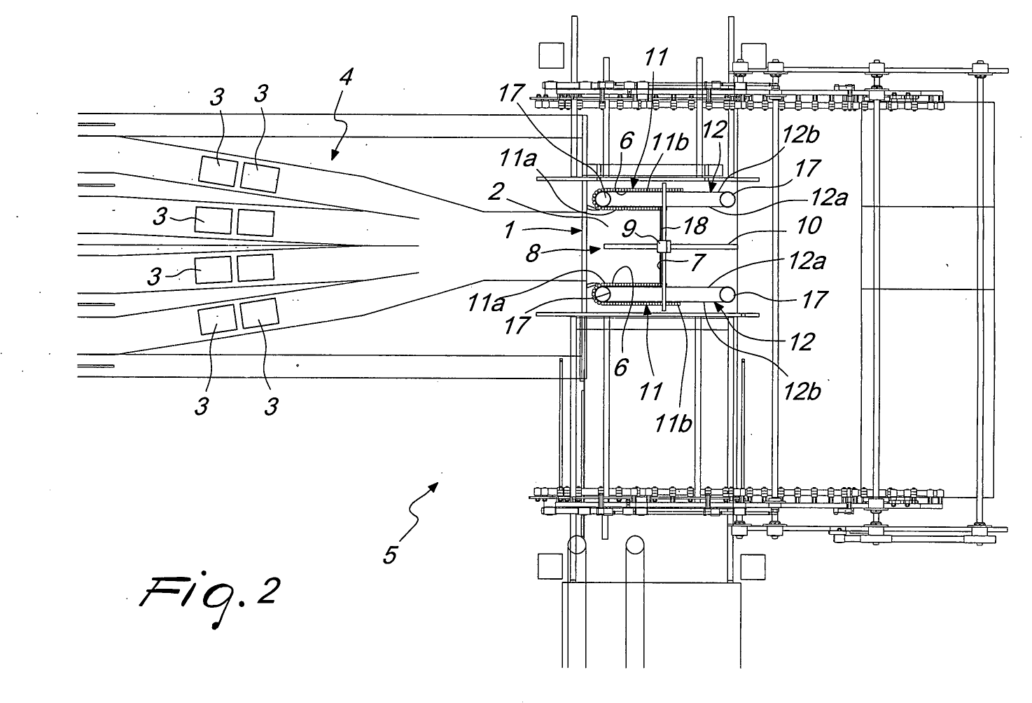

FIGS. 1 and 2 illustrate two possible different configurations of the station 1 according to the invention and of the compartment 2: in FIG. 1, the containment element 11 is almost entirely arranged along the first extent 11a, in order to achieve the maximum length of the side wall 6 and therefore the maximum depth of the compartment 2.

From this configuration, by sliding the containment element 11 along one of the annular portions and then along the second extent 12b, it is possible to reduce the useful portion 11a arranged along the first extent 12a, thus reducing the length of the side wall 6 and therefore the depth of the compartment 2, obtaining for example the configuration shown in FIG. 2.

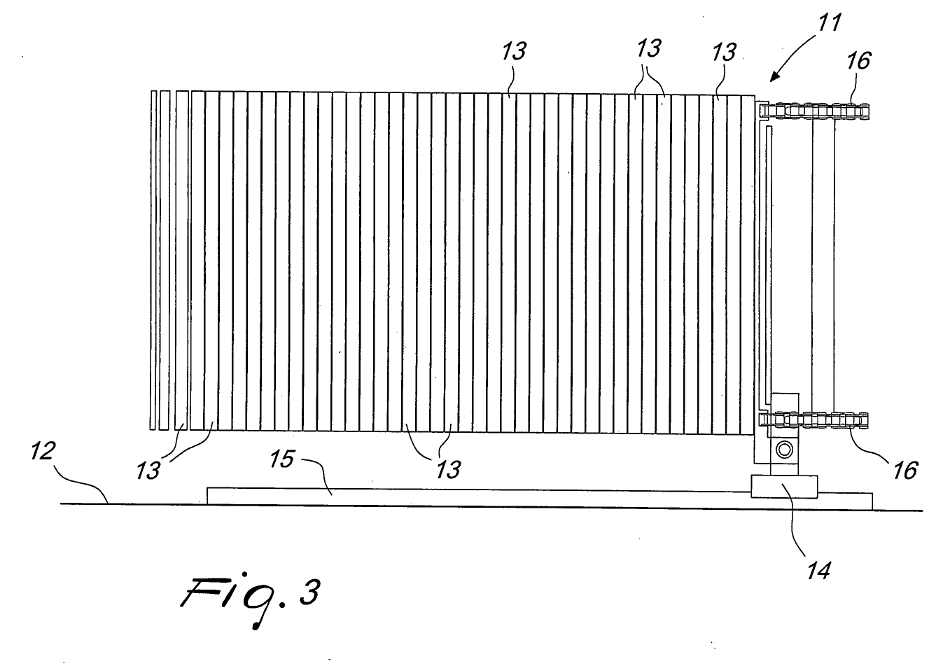

According to an embodiment of considerable practical interest, illustrated by way of non-limiting example in particular in FIG. 3, the containment element 11 comprises a plurality of slats 13, which are mutually laterally adjacent and articulated along axes that are perpendicular to the plane that contains the closed path 12. The slats 13 thus form substantially a blind, which is arranged along a fraction of the closed path 12 and can slide thereon.

Conveniently, each containment element 11 comprises at least one chain 16, shown in FIG. 3, which is fixed to at least one end slat 13 of each blind and is arranged along the free fraction of the closed path 12.

In particular, the chain 16 is fixed, at its two ends, to the two end slats 13 of the blind, in practice covering completely, together with said blind, the extension of the closed path 12.

More particularly, each containment element 11 comprises two chains 16, which are mutually parallel and are fixed respectively to the base and to the top of at least one of the end slats 13.

According to one possible embodiment, the sliding of the containment element 11 is allowed by at least one carriage 14, which is fixed laterally to the blind formed by the slats 13 and can slide along a guide 15 that is shaped according to the closed path 12.

Advantageously, the receiving and temporary accommodation station 1 comprises handling means, which are capable of sliding each containment element 11 along the closed path 12.

In particular, such handling means can comprise two pulleys 17, each subtended by an annular portion of a respective closed path 12. At the other end extent there is a simple supporting and guiding element. Each pulley 17 can rotate about its own axis, which is parallel to the slats 13, and meshes with the blind formed by the slats 13 in order to slide it along the closed path 12.

As an alternative, each pulley 17 can mesh with the chain 16 in order to drive it slidingly along the closed path 12 and again move the blind with it.

It should be noted that the transmission of the movement provided by means of the mating between the pulley 17 and the chain 16 is more effective and reliable than transmission achieved by means of the simple mating between the pulley 17 and the blind. It is thus possible to obtain a solution that has better operation on the part of the involved elements.

According to a third possible embodiment, the handling means comprise two pairs of pulleys 17, one for each containment element 11, and each pulley 17 is subtended by a respective annular portion of the corresponding closed path 12. On each closed path 12, a pulley 17 can thus mesh with the blind, while the other pulley 17 meshes with the chain 16 that is fixed to the blind: the sliding movement of the containment element 11 is thus provided by means of the pulley 17 that is mated with the chain 16, as well as by means of the other pulley, which is mated with the blind.

In order to allow the compartment 2 to contain products 3 of different widths, at the back wall 7 the station 1 has a flat element 18, whose length is adapted to contain products 3 of maximum width and which is made for example of light alloy and connected to the above cited shock-absorbing element.

The back wall 7 is thus constituted by a central region of the flat element 18, such central region being delimited by the useful portions 11a of the containment elements 11, and in particular by the end slats 13 that are adjacent to the flat element 18. The movement of the containment elements 11 along the direction that is parallel to the flat element 18 therefore allows to vary the width of the central region and of the compartment 2.

Conveniently, the station 1 comprises means for rigid connection between the flat element 18 and the containment element 11: by way of such rigid connection means, the sliding of the flat element 18 along the direction that is parallel to the side walls 6 (therefore along the track 10) is associated functionally with the sliding of the containment element 11 along the closed path 12.

By making the flat element 18 slide, in order to vary the depth of the compartment 2, as a direct consequence a corresponding sliding of the containment element 11 is therefore obtained in order to vary the length of the useful portion 11a or vice versa.

Ultimately, therefore, it is possible to vary the depth of the compartment 2 by means of a single adjustment, which affects simultaneously both the back wall 7 and the side walls 6.

The operation of the station according to the invention is as follows.

In order to allow an adjustment of the compartment 2 such as to adapt to the width variations of the products 3, it is sufficient to make the containment elements 11 slide parallel to the flat element 18, thus reducing or increasing the width of the compartment 2 and the size of the useful region of the flat element 18, which is indeed delimited by the useful portions 11a of the containment element 11.

The outer regions of the flat element 18, which are not involved in the containment of the products 3, can protrude beyond the first extent 12a: as indeed can be deduced from the above description and from FIGS. 1 and 2, the first extent 12a of the closed path 12 has a “closed” segment, on which the useful portion 11a is arranged, and a residual “open” segment, along which only the chain 16 slides, and which therefore can be crossed by the outer regions of the flat element 18.

It is therefore evident that the station 1 according to the invention does not require operator interventions to replace the flat element 18 as a consequence of variations in the width of the products 3; it is in fact already capable of containing the maximum format of the products 3, and by making the useful portions 11a of the containment element 11 slide adequately it is possible to reduce their central region that in practice constitutes the back wall 7.

If it is necessary to adjust the compartment 2 in order to change its depth, it is sufficient to make the back wall 7, constituted by the central region of the flat element 18, slide along the track 10 and simultaneously make the containment element 11 slide along the closed path 12 in order to vary the length of the useful portion 11a and therefore the length of the side walls 6. The two movements, as already noted, can be associated by way of the rigid connection means between the flat element 18 and the containment elements 11.

The receiving and temporary accommodation station 1 according to the invention is thus very strong and reliable thanks to the presence of a flat element 18 made of light alloy, while the effectiveness and lightness of the shock-absorbing action are ensured by the fact that the involved element is substantially only the flat element 18.

In practice it has been found that the station according to the invention fully achieves the intended aim, since in order to allow the station to adapt to a change of format of the products to be treated it is sufficient to make the back wall and the containment element slide in order to vary its useful portion, which constitutes the side wall, thus avoiding the need for the intervention of an operator and at the same time ensuring that the station has the desired mechanical simplicity.

The invention thus conceived is susceptible of numerous modifications and variations, all of which are within the scope of the appended claims; all the details may further be replaced with other technically equivalent elements.

For example, the containment element 11 can have a configuration that is different from the one described, i.e., it is possible to provide containment elements 11 that comprise a platform or a flexible belt, which can slide along the predefined closed path 12, like the blind constituted by the plurality of slats 13 described above.

As an alternative, the scope of the protection defined by the present invention includes solutions that have a containment element 11 in which a useful portion can slide and be arranged along the extent 12a, while the remaining portion can wrap around an axis that is arranged proximate to the peripheral region of the wall, for example in a receptacle provided at one of the pulleys 17 cited above.

In the exemplary embodiments shown, individual characteristics, given in relation to specific examples, may actually be interchanged with other different characteristics that exist in other exemplary embodiments.

Moreover, it is noted that anything found to be already known during the patenting process is understood not to be claimed and to be the subject of a disclaimer.

In practice, the materials used, as well as the dimensions, may be any according to requirements and to the state of the art.

The disclosures in Italian, Patent Application No. B02008A000331 from which this application claims priority are incorporated herein by reference.

Where technical features mentioned in any claim are followed by reference signs, those reference signs have been included for the sole purpose of increasing the intelligibility of the claims and accordingly such reference signs do not have any limiting effect on the interpretation of each element identified by way of example by such reference signs.

1-11. (canceled)

12. A station for receiving products and temporarily accommodating them, comprising a compartment that is delimited by two mutually opposite side walls and by a back wall, which lies opposite an open side of said compartment that constitutes an inlet for products to be received and accommodated temporarily, said back wall being movable along a direction that is parallel to said side walls in order to vary the depth of said compartment and said side walls being movable along a direction that is parallel to said back wall in order to vary the width of said compartment, wherein each one of said side walls is constituted by a useful portion of a containment element, said containment element being at least partially able to slide parallel to itself in order to vary the length of said useful portion.

13. The station according to claim 12, wherein each one of said containment elements can slide along a respective predefined closed path, which has at least one substantially straight first extent, which faces said compartment, the part of said containment element that is arranged along said first extent constituting said useful portion.

14. The station according to claim 13, wherein said closed path comprises a second extent, which is arranged outside said compartment and parallel to said first extent, and two annular portions for connection between said first extent and said second extent, along at least one of said annular connecting portions and along said second extent there being the remaining portion of said containment element.

15. The station according to claim 13, wherein said containment element comprises a plurality of slats which are arranged side by side and mutually articulated, along axes which are perpendicular to the plane that contains said closed path, so as to form substantially a blind that is arranged along a fraction of said closed path and can slide on it.

16. The station according to claim 15, wherein each one of said containment elements comprises at least one chain, which is fixed to at least one end slat of said blind and is arranged along a free fraction of said closed path.

17. The station according to claim 16, wherein each one of said containment elements comprises two of said chains, which are mutually parallel and are fixed respectively to the base and to the top of said at least one end slat.

18. The station according to claim 13, further comprising handling means for each one of said containment elements in order to slide said elements along said closed path.

19. The station according to claim 18, wherein said handling means comprise at least one pulley, which is subtended by a respective annular portion of said of each closed path, each one of said pulleys being able to rotate about its own axis, which is parallel to said slats, and being functionally associated with a respective blind of a corresponding containment element, for the sliding movement thereof along said closed path.

20. The station according to claim 19, wherein said handling means comprise two of said pulleys, which are subtended by said annular portions of each one of said closed paths, one of said pulleys meshing with said blind and the other one of said pulleys meshing with said at least one chain, for the sliding movement of said containment element along said closed path.

21. The station according to claim 15, wherein said back wall is constituted by the central region of a flat element, said central region being delimited by the end slats of said blind that are adjacent to said flat element, said containment elements being movable along a direction that is parallel to said flat element in order to vary the width of said central region and of said compartment.

22. The station according to claim 21, further comprising means for rigid connection between said flat element and said containment element, the sliding of said flat element along the direction that is parallel to said side walls being functionally associated with the sliding of said containment element along said closed path by way of said rigid connection means.
